(19) United States
(12) Patent Application Publication
(10) Pub. No.: US 2017/0330193 A1
(43) Pub. Date: Nov. 16, 2017

(54) GEOGRAPHIC MOBILE CUSTOMER RELATIONS MANAGEMENT WITH BESPOKE GRAPHICAL SELECTION AND QUERY MODES

(71) Applicant: Badger Mapping Solutions LLC, San Francisco, CA (US)

(72) Inventor: Aaron Tolson, San Francisco, CA (US)

(21) Appl. No.: 15/666,522

(22) Filed: Aug. 1, 2017

Related U.S. Application Data
(63) Continuation-in-part of application No. 14/263,998, filed on Apr. 28, 2014.
(60) Provisional application No. 61/816,617, filed on Apr. 26, 2013.
(60) Provisional application No. 62/369,743, filed on Aug. 1, 2016.

(51) Int. Cl. G06Q 30/00; G06Q 30/02; G06Q 10/10; G06F 3/0484; G01C 21/36; H04W 4/02

(52) U.S. Cl. CPC G06Q 30/01; H04W 4/02; G06Q 30/0205; G01C 21/3614; G06F 3/04847; G01C 21/367; G06Q 10/1095

(57) ABSTRACT

A system for geographic mobile customer relations management, using a mobile customer relations management system manager connected to at least one mobile-capable network-connected computing device configured to graphically identify, manage and update customer relations management data in a geographic context and configured to organize customer relations management data based on at least one specific real-time queried variable using a selective graphical encapsulating function and/or graphical query mode to yield optimal routes to location-based customers, with an option to optimize schedules and appointments based on real-time customer relations management data available in a customer relations management system.

### CROSS-REFERENCE TO RELATED APPLICATIONS

This application is a continuation-in-part of U.S. patent application Ser. No. 14/263,998, titled “GEOGRAPHIC MOBILE CUSTOMER RELATIONS MANAGEMENT”, and filed on Apr. 28, 2014, which claims the benefit of, and priority to, U.S. provisional patent application Ser. No. 61/816,671, titled, “GEOGRAPHIC MOBILE CUSTOMER RELATIONS MANAGEMENT” and filed on Apr. 26, 2013, and also claims the benefit of and priority to U.S. provisional patent application Ser. No. 62/369,743, titled “GEOGRAPHIC MOBILE CUSTOMER RELATIONS MANAGEMENT WITH ROUTE MODE AND LASSO FEATURES” and filed on Aug. 1, 2016, the specification of each of which is incorporated herein by reference in its entirety.

### BACKGROUND OF THE INVENTION

### Field of the Art

The invention relates to the field of customer relations management, and more particularly to the field of mobile software for customer relations management.

### Discussion of the State of the Art

In the field of customer relations management (CRM), there exists a class of salesperson that tends to spend a large amount of time in the field, interacting with potentially hundreds of accounts per day spread across a geographic territory. The most appropriate method for such a salesperson to consume or interact with CRM data would be in a geographic context. Additionally, according to an IDC survey 59% of companies are planning to increase focused spending on mobile technologies, with mobile CRM solutions being a dominant focus.

A mobile salesperson may encounter challenges such as a lack of solutions for intuitive, easy to use CRM access in the field, or too many accounts to track on a traditional spreadsheet or similar format while driving, causing a loss of productivity or missed sales. Additionally, schedules, priorities, locations, and traffic or accessibility to clients all affect optimal efficiency of a mobile salesperson, with each consideration needing to be managed while keeping abreast of real-time changes to CRM data, either by the mobile salesperson or by others.

What is needed, is a mobile solution for viewing or interacting with CRM data in a geographic context, that is easy to use and intuitive for salesperson use regardless of technological ability and with minimal up-training required for adoption. Further what is needed is system and method to graphically identify, manage and update CRM data within a geographic context, and organize it based on at least one specific real-time queried variable, such, for example, proximity, accessibility, priority, status, type, specialty or similar-such field.

### SUMMARY OF THE INVENTION

Accordingly, the inventor has conceived and reduced to practice, in a preferred embodiment of the invention, a system for geographic mobile CRM data interaction.

According to a preferred embodiment of the invention, a system for geographic mobile CRM data interaction comprising a CRM server that may manage CRM features and operations, a database that may store CRM information such as customer accounts, an application server that may operate software means for interaction with a CRM server, and a web server that may provide network-accessible means for user interaction, is disclosed. According to the embodiment, an application server may provide interactive means such as a webpage or web-enabled software application, for example a mobile application operating on a user's mobile device (such as a smartphone, tablet computing device, or other appropriate electronic device for interaction). Such means may be accessible via web interaction, for example via a network-connected device (such as exemplary mobile devices described above), or via an Internet browser or other network interaction means, and such interaction may be facilitated by a web server.

According to the embodiment, such a system may be employed for such purposes as to enable mobile CRM management and interaction such as by a user on a mobile device, for example a mobile sales associate using a smartphone while in the field to manage customer account information. In this manner, it becomes possible for CRM operation to take place as needed, such as when a customer makes a change or request, rather than having to be delegated for later handling by a CRM associate using a traditional CRM management means, such as is common in the art. For example, as envisioned by the inventor, a mobile software application may be utilized to provide a user-friendly and functional graphical user interface (GUI) for interaction with CRM information, via interaction with the components of a mobile CRM system as described herein. In this manner, CRM management may be facilitated in a user-friendly manner with minimal learning curve and maximized functionality, while incorporating existing CRM components that may already be in use (such as a pre-existing CRM database), by extending existing functionality through the addition of system components describe herein to facilitate mobile management.

According to the embodiment, a mobile CRM management system may comprise a tile server that may provide discrete portions of data to expedite operation and interaction (such as may be necessary for use on mobile devices or in other situation where computing resources may limit the ability to render large amounts of data simultaneously), and an object relational mapping (ORM) server that may facilitate association of data with locational information such as geographic information (for example, a user's physical location or address). According to the embodiment, by utilizing geographical information such as might be obtained from a user device (for example, a mobile smartphone or tablet computing device that may ordinarily provide location data on request), it becomes possible to associate this geographical information with CRM data such as user account information, for such purposes as to (for example) provide a location-based view of customer information such as concentrations of existing customers or locations of potential future customers, or to provide this location-enabled information for further processing such as to determine areas where new customers are likely or areas where existing customers may be more receptive to additional sales (or any other such CRM-focused use that may be enhanced through utilization of geographic or other location-based information).

Accordingly, the inventor has conceived and reduced to practice, in a preferred embodiment of the invention, a system for mobile customer relations management of a customer relations management system or network, using a mobile customer relations management system manager, comprising at least one mobile-capable network-connected computing device, comprising a processor, a memory, and a plurality of programming instructions stored in the memory and operable on the processor; wherein the plurality of programming instructions are configured to graphically identify, manage and update customer relations management data in a geographic context; and wherein the plurality of programming instructions are configured organize customer relations management data based on at least one specific real-time variable associated with the customer relations management system. The following non-limiting summary of the invention is provided for clarity, and should be construed consistently with embodiments described in the detailed description below.

According to another preferred embodiment of the invention, a system for mobile customer relations management of a customer relations management system or network, using a mobile customer relations management system manager, comprising at least one mobile-capable network-connected computing device, comprising a processor, a memory, and a plurality of programming instructions stored in the memory and operable on the processor; wherein the plurality of programming instructions are configured to graphically identify, manage and update customer relations management data in a geographic context; and wherein the plurality of programming instructions are configured organize customer relations management data based on at least one specific real-time variable associated with the customer relations management system, with the mobile customer relations management system manager further comprising: a customer relations management system connected to a database containing customer relations management information and data, stored and operating on a network-connected computing device; a routing manager, stored and operating on a network-connected computing device, configured to manage routing by way of interaction with a mapping service, a location tracker and a routing generator; an event manager with access to a calendaring server, stored and operating on a network-connected computing device, configured to manage events in calendars, associated with the customer relations management data; a tile server stored and operating on a network-connected computing device, configured to provide data portions of customer relations management data to a graphical interface in conjunction with a display driver, and display images and options in highlighted colors, hues, transparencies, and other visually stimulating indicia to indicate at least an optimal routing option; a display driver stored and operating on a network-connected computing device, configured to decide what to show based on a query made by the query manager, yielding a ‘result set’, and to decide what imagery and data to send to the tile server, what icon to display for a target, what color to display, what a mapped illustration may look like, with what size of lettering and font, based on a plurality of options/categories available through a graphical interface; a query manager stored and operating on a network-connected computing device, configured to select, query and return a data set based on a text-based or graphical query against data in the customer relations management system; a graphical interface stored and operating on a network-connected computing device, configured to interact with the mobile customer relations management system manager and a mobile network-connected device; and an object-relational mapping system, stored and operating on a network-connected computing device, with access to an object-relational mapping database; wherein the query manager identifies data targets from customer relations management information provided by a customer relationship management service via a network to derive a subset of customer relationship management information relevant to a business user at a specific location; wherein the object relational mapping server associates location information received from a mobile device of a business user with customer relations management information provided by a customer relationship management service via a network to derive a subset of customer relationship management information relevant to a business user at a specific location; wherein the tile server transmits the derived subset of customer relationship management information for display as a map overlay on the mobile-capable network-connected computing device; wherein the routing manager incorporates routing results from the routing generator and location results from the location tracker to determine optimal routes for accessing a business user's location; wherein the event manager associates schedules and appointment timings from a calendaring server connected to a mobile-capable network-connected computing device of a business user with customer relations management information provided by a customer relationship management service via a network to derive a subset of customer relationship management information relevant to the business user at a specific location; and wherein customer relations management data is a derived subset of customer relationship management information comprising at least a plurality of identities of existing customers located near a business user, is disclosed.

According to another preferred embodiment of the invention, a method to graphically identify, manage and update customer relations management data within a geographic context, and organize it based on at least one specific queried variable, using a query-lasso function, activated by a mobile customer relations management system manager working in real-time, comprising the steps of: accessing location-based customer relations management data within a customer relations management system, using a mobile customer relations management system manager; initiating an initial query against the customer relations management data using a query manager; processing and sorting, with the query manager, and further distributing queried results as data targets to applicable components within the mobile customer relations management system manager; locating the customer relations management data targets on an electronic map; displaying results graphically on the electronic map in a display window, affording a plurality of optional visual indicia which may be used to highlight any queried features; optionally modifying the initial query against the customer relations management data using a query manager; drawing, with a graphical interface, a ‘lasso’, comprised of a series of lines, either straight or curved, to encapsulate and surround at least one desired customer relations management data target; determining, with a routing manager, which data targets are within the encapsulated envelope surrounded by the lasso, and which data targets are not within the lasso; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the ‘lasso’; calculating and generating at least one optimal route or optimal schedule of appointments occurring at a plurality of locations; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map, is disclosed.

According to a preferred embodiment of the invention, a method to graphically identify, manage and update customer relations management data within a geographic context, and organize it based on at least one specific queried variable, using a lasso-query function, activated by a mobile customer relations management system manager working in real-time, comprising the steps of: accessing location-based customer relations management data within a customer relations management system, using a mobile customer relations management system manager; locating the customer relations management data targets on an electronic map; displaying results graphically on the electronic map in a display window, affording a plurality of optional visual indicia which may be used to highlight any queried features; drawing, with a graphical interface, a ‘lasso’, comprised of a series of lines, either straight or curved, to encapsulate and surround at least one desired customer relations management data target; initiating a query against the customer relations management data using a query manager; processing and sorting, with the query manager, and further distributing queried results as data targets to applicable components within the mobile customer relations management system manager; determining, with a routing manager, which data targets are within the encapsulated envelope surrounded by the lasso, and which data targets are not within the lasso; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the ‘lasso’; calculating and generating at least one optimal route or optimal schedule of appointments occurring at a plurality of locations; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map, is disclosed.

According to a preferred embodiment of the invention, a method to graphically identify, manage and update customer relations management data within a geographic context, and organize it based on at least one specific queried variable, using a lasso-query function, activated by a mobile customer relations management system manager working in real-time, comprising the steps of: accessing location-based customer relations management data within a customer relations management system, using a mobile customer relations management system manager; locating the customer relations management data targets on an electronic map; displaying results graphically on the electronic map in a display window, affording a plurality of optional visual indicia which may be used to highlight any queried features; drawing, with a graphical interface, a ‘lasso’, comprised of a series of lines, either straight or curved, to encapsulate and surround at least one desired customer relations management data target; initiating a query against the customer relations management data using a query manager; processing and sorting, with the query manager, and further distributing queried results as data targets to applicable components within the mobile customer relations management system manager; determining, with a routing manager, which data targets are within the encapsulated envelope surrounded by the lasso, and which data targets are not within the lasso; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the ‘lasso’; calculating and generating at least one optimal route or optimal schedule of appointments occurring at a plurality of locations; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map, drawing, with a graphical interface, at least a second ‘lasso’, comprised of a series of lines, either straight or curved, to encapsulate and surround at least one desired customer relations management data target, where the at least first and second lasso do not intersect; initiating a query against the customer relations management data using a query manager; processing and sorting, with the query manager, and further distributing queried results as data targets to applicable components within the mobile customer relations management system manager; determining, with a routing manager, which data targets are within the encapsulated envelope surrounded by the at least first and second lassos, and which data targets are not within the at least first and second lassos and; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the at least first and second lassos; calculating and generating at least one optimal route or optimal schedule of appointments occurring at a plurality of locations within the at least first and second lassos; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map is disclosed.

According to a preferred embodiment of the invention, a method to graphically identify, manage and update customer relations management data within a geographic context, and organize it based on at least one specific queried variable, using a lasso-query function, activated by a mobile customer relations management system manager working in real-time, comprising the steps of: accessing location-based customer relations management data within a customer relations management system, using a mobile customer relations management system manager; locating the customer relations management data targets on an electronic map; displaying results graphically on the electronic map in a display window, affording a plurality of optional visual indicia which may be used to highlight any queried features; drawing, with a graphical interface, a ‘lasso’, comprised of a series of lines, either straight or curved, to encapsulate and surround at least one desired customer relations management data target; initiating a query against the customer relations management data using a query manager; processing and sorting, with the query manager, and further distributing queried results as data targets to applicable components within the mobile customer relations management system manager; determining, with a routing manager, which data targets are within the encapsulated envelope surrounded by the lasso, and which data targets are not within the lasso; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the ‘lasso’; calculating and generating at least one optimal route or optimal schedule of appointments occurring at a plurality of locations; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map, drawing, with a graphical interface, at least a second ‘lasso’, comprised of a series of lines, either straight or curved, to encapsulate and surround at least one desired customer relations management data target, where the at least first and second lasso intersect; initiating a query against the customer relations management data using a query manager; processing and sorting, with the query manager, and further distributing queried results as data targets to applicable components within the mobile customer relations management system manager; determining, with a routing manager, which data targets are within the combined encapsulated envelope surrounded by the at least first and second lassos, and which data targets are not within the at least first and second lassos and; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the combined area of the atleast first and second lassos; calculating and generating at least one optimal route or optimal schedule of appointments occurring at a plurality of locations within the combined area of the atleast first and second lassos; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map is disclosed.

According to a preferred embodiment of the invention, a method to graphically identify, manage and update customer relations management data within a geographic context, and organize it based on at least one specific queried variable, using a lasso-query function, activated by a mobile customer relations management system manager working in real-time, comprising the steps of: accessing location-based customer relations management data within a customer relations management system, using a mobile customer relations management system manager; locating the customer relations management data targets on an electronic map; displaying results graphically on the electronic map in a display window, affording a plurality of optional visual indicia which may be used to highlight any queried features; drawing, with a graphical interface, a ‘lasso’, comprised of a series of lines, either straight or curved, to encapsulate and surround at least one desired customer relations management data target; initiating a query against the customer relations management data using a query manager; processing and sorting, with the query manager, and further distributing queried results as data targets to applicable components within the mobile customer relations management system manager; determining, with a routing manager, which data targets are within the encapsulated envelope surrounded by the lasso, and which data targets are not within the lasso; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the ‘lasso’; calculating and generating at least one optimal route or optimal schedule of appointments occurring at a plurality of locations; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map, drawing, with a graphical interface, at least a second ‘lasso’, comprised of a series of lines, either straight or curved, to encapsulate and surround at least one desired customer relations management data target, where the at least second lasso completely intersects the first lasso; initiating a query against the customer relations management data using a query manager; processing and sorting, with the query manager, and further distributing queried results as data targets to applicable components within the mobile customer relations management system manager; determining, with a routing manager, which data targets are within the encapsulated envelope surrounded by the at least first and second lassos, and which data targets are not within the at least first and second lassos and which data targets are within both the at least first and second lassos; optionally modifying the query against the customer relations management data using a query manager; engaging and interacting with the customer relations management system, the mapping service, and/or the calendaring service, either simultaneously, individually or collectively, to apply queried customer relations management data results to location and schedule; modifying the display window to graphically depict the encapsulated data targets surrounded by the areas not common to the at least first and second lassos; calculating and generating at least one optimal route or optimal schedule of appointments occurring at a plurality of locations within the areas not common to the at least first and second lassos; tracking, with a location tracker, locations of all data targets and mobile devices accessing the mobile customer relations management system manager; updating optimal routes in real-time, using the routing manager of the mobile customer relations management system manager; and graphically illustrating the optimal route by displaying the location of the mobile customer relations management system manager centered on a graphical image of the electronic map whereby the map moves and tracks movement as the location of the mobile customer relations management system manager changes; or graphically illustrating the optimal route by displaying the location of the mobile customer relations management system manager moving about on a graphical image of the electronic map whereby the location of the mobile customer relations management system manager moves about on a static view of the electronic map is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for mobile CRM, according to a preferred embodiment of the invention.

FIG. 2 is a block diagram illustrating a more detailed exemplary system architecture for mobile CRM, according to a preferred embodiment of the invention.

FIG. 3 is a method flow diagram illustrating an exemplary method for mobile CRM, according to an embodiment of the invention.

FIG. 4 is a block diagram illustrating an exemplary system architecture for graphically identifying and managing CRM data within a geographic context, according to another preferred embodiment of the invention.

FIG. 5 is a block diagram illustrating a simplified exemplary system architecture for graphically identifying and managing CRM data within a geographic context, according to another preferred embodiment of the invention.

FIG. 6 is a method flow diagram illustrating an exemplary method for graphically identifying, managing and updating CRM data within a geographic context, according to another embodiment of the invention.

FIG. 7 is a method flow diagram illustrating an exemplary method for graphically identifying, managing and updating CRM data within a geographic context, according to another embodiment of the invention.

FIG. 8 is an exemplary user interface diagram depicting an exemplary system and method for graphically identifying and managing CRM data within a geographic context, according to an embodiment of the invention.

FIG. 9 is an exemplary user interface diagram depicting an exemplary system and method for graphically identifying and managing CRM data within a geographic context, according to an embodiment of the invention.

FIG. 10 is an exemplary user interface diagram depicting an exemplary system and method for graphically identifying and managing CRM data within a geographic context, according to an embodiment of the invention.

FIG. 11 is an exemplary user interface diagram depicting an exemplary system and method for graphically identifying and managing CRM data within a geographic context, according to an embodiment of the invention.

FIG. 12 is an exemplary user interface diagram depicting an exemplary system and method for graphically identifying and managing CRM data within a geographic context, according to an embodiment of the invention.

FIG. 13 is an exemplary user interface diagram depicting an exemplary system and method for graphically identifying and managing CRM data within a geographic context, according to an embodiment of the invention.

FIG. 14 is an exemplary user interface diagram depicting an exemplary system and method for graphically identifying and managing CRM data within a geographic context, according to an embodiment of the invention.

FIG. 15 is an exemplary user interface diagram depicting another exemplary system and method for graphically identifying and managing CRM data within a geographic context, according to an embodiment of the invention.

FIG. 16 is an exemplary user interface diagram depicting another exemplary system and method for graphically identifying and managing CRM data within a geographic context, according to an embodiment of the invention.

FIG. 17 is an exemplary user interface diagram depicting another exemplary system and method for graphically identifying and managing CRM data within a geographic context, according to an embodiment of the invention.

FIG. 18 is a block diagram illustrating an exemplary hardware architecture of a computing device used in an embodiment of the invention.

FIG. 19 is a block diagram illustrating an exemplary logical architecture for a client device, according to an embodiment of the invention.

FIG. 20 is a block diagram showing an exemplary architectural arrangement of clients, servers, and external services, according to an embodiment of the invention.

FIG. 21 is another block diagram illustrating an exemplary hardware architecture of a computing device used in various embodiments of the invention.

### DETAILED DESCRIPTION

The inventor has conceived, and reduced to practice, in a preferred embodiment of the invention, a system for mobile customer relations management of a customer relations management system or network, using a mobile customer relations management system manager, comprising at least one mobile-capable network-connected computing device, comprising a processor, a memory, and a plurality of programming instructions stored in the memory and operable on the processor; wherein the plurality of programming instructions are configured to graphically identify, manage and update customer relations management data in a geographic context; and wherein the plurality of programming instructions are configured organize customer relations management data based on at least one specific real-time variable associated with the customer relations management system. The following non-limiting summary of the invention is provided for clarity, and should be construed consistently with embodiments described in the detailed description below.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

As used herein, “data source” is any remote system that transmits information that is structured in such a way that rules can be applied to insure the reliable and accurate storage of that information in a local database. The “data source” as used here will most often be another, remote, database, but could also be a set of text files on a file server or extensive complex spreadsheet data from within a small sized, medium sized or large sized corporation without departing from the scope of the invention as claimed.

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various embodiments may preferentially employ one or another of the various data storage subsystems available in the art (or available in the future), the invention should not be construed to be so limited, as any data storage architecture may be used according to the embodiments. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, in a peer to peer arrangement or in a master/slave arrangement common in the art. These examples should make clear that no particular architectural approaches to database management is preferred according to the invention, and choice of data storage technology is at the discretion of each implementer, without departing from the scope of the invention as claimed.

### Conceptual Architecture

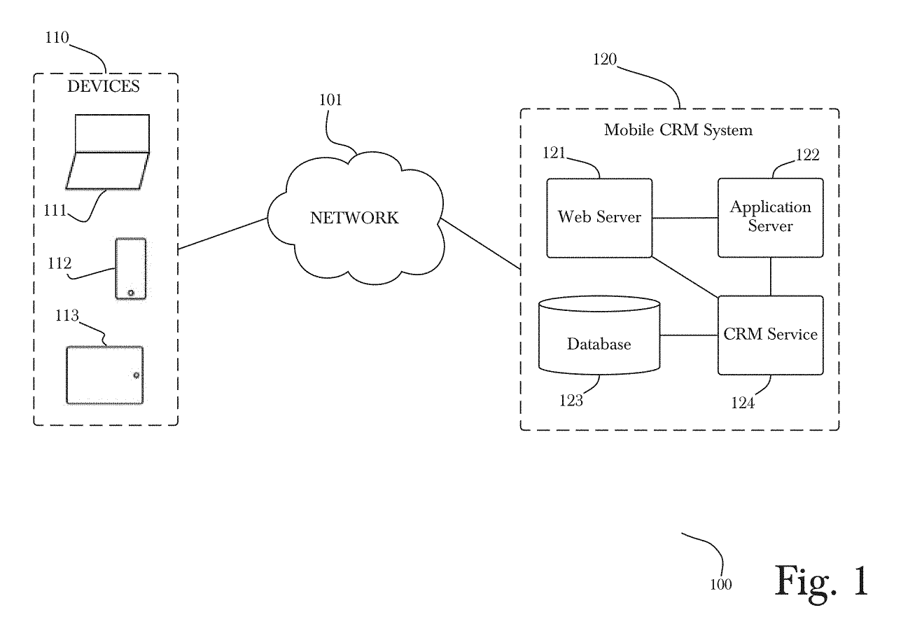

FIG. 1 is a block diagram illustrating an exemplary system architecture 100 for operating mobile CRM data for interaction such as by a mobile salesperson or other users using mobile devices 110, according to a preferred embodiment of the invention. As illustrated, various traditional components of a computing network may be interconnected and in communication via a network 101 connection, such as, for example, Internet or similar such data communications network. It should be appreciated by one having ordinary skill in the art, that such an arrangement is exemplary and a variety of connection and communication means exist which may be utilized according to the invention, and it should be further appreciated that various combinations of connections and communication means may be utilized.

As illustrated, a plurality of devices 110 may interact with a mobile CRM system 120 via a variety of hardware or software means common in the art, several examples of which are illustrated. It should be appreciated that such means as illustrated and described below are exemplary, and any of a variety of additional or alternate means may be utilized according to the invention. Hardware means may include (but are not limited to) electronic devices capable of communication over a network 101, such as a personal computer 111 (such as a laptop or desktop computer), mobile smartphone 112, or a tablet computing device 113. As appropriate and according to the specific nature of a device being utilized, devices 110 may interact using a variety of software means (not illustrated), such as a web browser accessing a webpage or other internet-enabled software (as may be appropriate when using a personal computer 111), or a mobile application (as may be appropriate when using a mobile smartphone 112 or tablet computing device 113). It should be appreciated that, as with physical devices 110 described above, such means as described are exemplary and a variety of additional or alternate means may be utilized according to the invention.

As further illustrated, devices 110 may communicate across a network 101 or similar communication connection, for such purposes as interaction with a social media management system as a CRM system 120, various components of which may be similarly connected to a network 101 for communication, and which may also be interconnected within system 120 for communication with other components. Such components may include (but are not limited to) a web server 121 that may operate web-accessible content such as web pages or interfaces for viewing on devices 110 and also may receive web interactions from devices 110; an application server 122 that may operate various software elements for interaction such as via web-enabled means operated by web server 121; a database 123 or similar data storage component that may store data from other components as well as provide such stored data for interaction (such as for viewing or modifying existing data), and a CRM service 124 that may operate software components facilitating management of social media content or business-to-business transpactions.

As illustrated, CRM service 124 may be connected and in communication with other components such as application server 122 such as to provide functionality for interaction via software elements (as may be appropriate for incorporating social media management functionality in other software elements, as described in greater detail below), web server 121 such as to provide functionality for interaction via web pages or similar web-enabled means, and database 123 such as to store and retrieve information relevant to agreement management. In this manner it can be appreciated that a function of CRM service 124 may be to provide functionality to other components that may operate specific means of interaction, while still optionally providing functionality directly to user applications or devices 110, thereby enabling a variety of arrangements and means of interaction according a preferred embodiment of the invention.

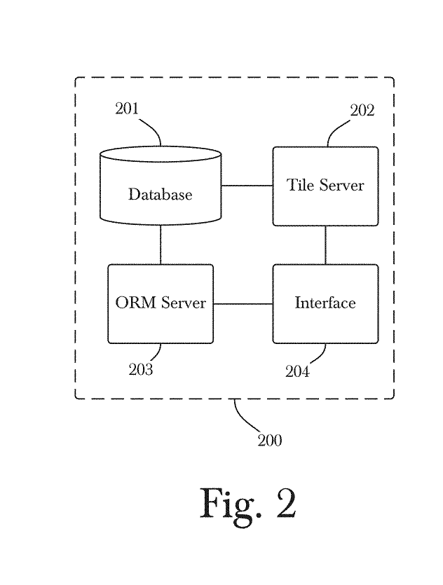

FIG. 2 is a block diagram illustrating a more detailed exemplary system 200 for providing mobile CRM functionality, such as might be utilized as a CRM Service 124 as described above (referring to FIG. 1), according to a preferred embodiment of the invention. As illustrated, internal components of system 200 may be interconnected such as for communication between components, and it should be appreciated that additional or alternate connections or components may be utilized according to the invention, those illustrated being exemplary for illustration of basic function of system 200.

As illustrated, a database 201 may be utilized for such purposes as to store and serve CRM data or other potentially-relevant information such as geographic information (map images, logged GPS data, or other such location-based information) to other components of system 200 or to connected user devices 110. Database 201 may be of varied design and implementation, such as a physical datastore (such as a tape deck, optical disc, hard disk drive or other physical storage medium as are common in the art) or a software-based storage or organizational system such as a SQL-based database or cloud storage, or other software-based data storage format.

As further illustrated, a tile server 202 may be utilized for such purposes as serving “tiles” of information, essentially discrete portions of a whole, rather than serving large portions of information at a time, increasing efficiency by decreasing load and latency. Such functionality may be useful particularly for geographic data, such as loading small map tiles rather than a larger map view when only a portion is required—i.e., if a user device 110 requests the geographic view for a specific ZIP code or street, only an immediate area may be presented rather than, for example, loading map data for an entire region.

As further illustrated, an object relational mapping (ORM) server 203 may be utilized, and may perform object-mapping tasks such as (for example) user authentication or mapping CRM data to geographic locations. It will be appreciated by one having ordinary skill in the art that a variety of object-mapping use cases are possible and may be utilized according to the invention.

As further illustrated, a user interface 204 may be utilized such as to allow a connected user device 110 to interact with various components of system 200 such as to view or interact with CRM data. Such an interface may be of varied nature according to a preferred embodiment, but as envisioned by the inventor, should be an adaptable software application programming interface (API) such that system 200 may be interfaced with a variety of end products or devices 110 such as tablet computing devices 113 or smartphones 112, and such that third-party or additional components may easily be integrated with system 200 such as to enhance function. In this manner, system 200 may be accessible to user devices 110 regardless of their individual requirements, facilitating a more flexible design and improving user convenience and availability of content.

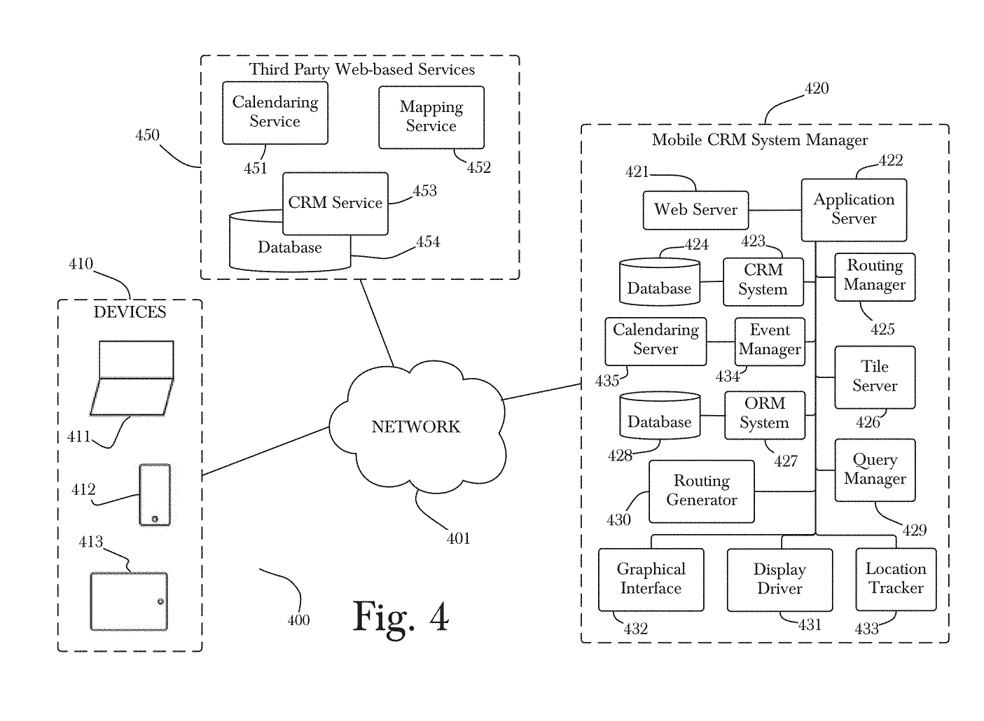

FIG. 4 is a block diagram illustrating an exemplary system architecture 400 for graphically identifying, managing and updating CRM data within a geographic context by at least one device 410 using a mobile CRM system manager 420 connected over a network 401. Third party web services 450 by the mobile CRM system manager 420 may be accessed over the network 401 or may be accessed over a separate network 401, meaning, system 400 may be connected over a plurality of networks 401, as required by the set-up and protocols of the mobile CRM system manager 420. It should be appreciated by one having ordinary skill in the art, that such an arrangement is exemplary and a variety of connection and communication means exist which may be utilized according to the invention, and it should be further appreciated that various combinations of connections and communication means may be utilized.

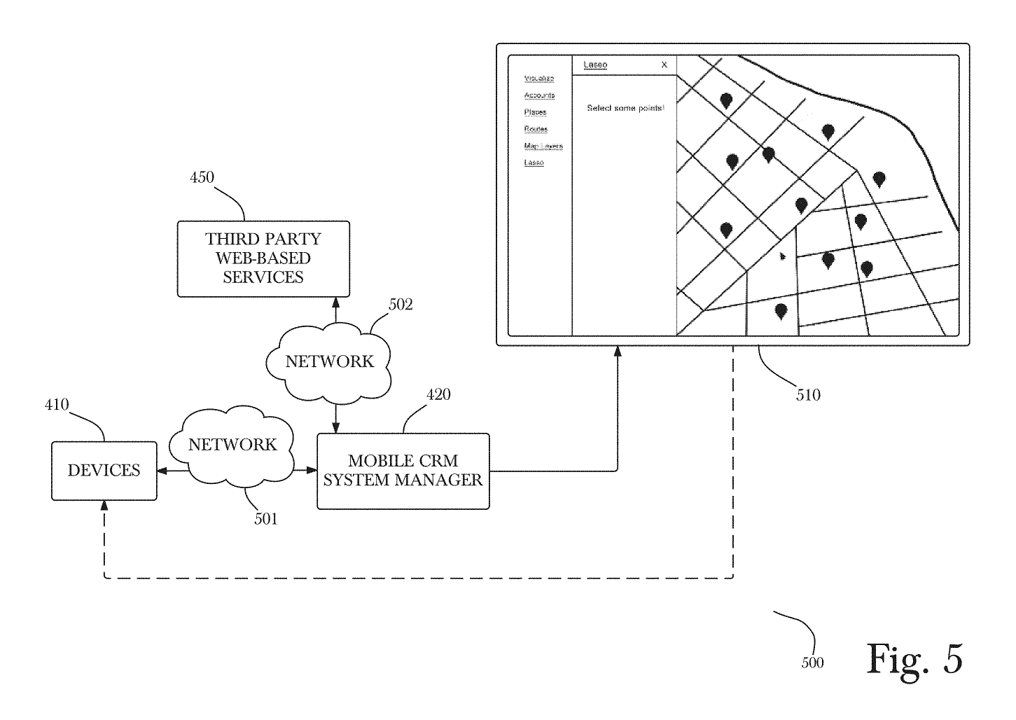

User devices 410, such as a personal computer 411 or laptop 411, mobile smartphone 412 or tablet computing device 413 may be used to access and utilize a mobile CRM system manager 420, of which some components may be local to the device 410 as established by specific settings for optimal efficiency of system 400. As appropriate and according to requirements of the device 410 being utilized, devices 410 may interact using a variety of software means (not illustrated), such as a web browser accessing a webpage or other internet-enabled software (as may be appropriate when using a personal computer 411), or a mobile application (as may be appropriate when using a mobile smartphone 412 or tablet computing device 413). It should be appreciated that, as with physical devices described above, such means as described are exemplary and a variety of additional or alternate means may be utilized according to the invention. Devices 410 may communicate across a network 401 or similar communication connection, for such purposes as interaction with a mobile CRM system manager 420, various components of which may be similarly connected to a network 401 for communication, and which may also be interconnected within mobile CRM system manager 420 for communication with other components. Such components may include (but are not limited to) a web server 421 that may operate web-accessible content such as webpages or interfaces for viewing by devices 410 and also may receive web interactions from devices 410, an application server 422 that may operate various software elements for interaction such as via web-enabled means operated by web server 421, a database 424 or similar data storage component that may store data from other components as well as provide such stored data for interaction (such as for viewing or modifying existing data) via a CRM system 423 that may operate software components facilitating management of accounts or other social media content. In another configuration of a mobile CRM system manager 420, CRM system 423 and database 424 may be partially or fully replaced by a CRM service 453 and a database 454 within a third party web-based service 450. In this way, it should be understood that access to various systems may be internal to mobile CRM system manager 420 or may be augmented or replaced by third party web-based services 450, depending on configuration, preferences and requirements of devices 410 in system 400. Similarly, schedules may be updated and maintained by an event manager 434 accessing a calendaring server 435 or a calendaring service 451. Event manager 434 especially works with a routing manger 425 and a query manager 429, but is also in communication with all components of the mobile CRM system manager 420 as illustrated. The event manager 434 may manage events, considering timings provided by the routing manager 425 for travel, appointments established and managed in a calendar from either the calendaring server 435 or calendaring service 451, and/or manual updates made within the mobile CRM system manager 420 by a device 410 using a graphical interface 432 to prompt and input and manage such data. The event manager 434 manages events such that schedules may be managed in real-time, and along with the event manager 434, the routing manager 425 interfaces with a mapping service 452, such as, for example, Google™ powered maps, for providing location-based mapping, a routing generator 430 which calculates a plurality of routes and determines at least one optimal route to a target location, a tile server 426 which may work with a display driver 431 to customize data on a map by drawing and depicting images and targets from a plurality of tiles and layers, an object relational mapping (ORM) system 427 and associated database 428 which may perform object-mapping tasks, such as, for example, device 410 authentication or mapping CRM data to geographic locations, a query manager 429 which may be used to return a data set from a CRM system 423 or CRM service 453, a location tracker 433 which may be used to determine and update location for each device and respective target, a display driver 431 which may be used to decide what to show based on a query made by the query manager 429, which may yield a ‘result set’, and decides what to send to the tile server 426, what icon to display for a target, what color to display, what a mapped illustration may look like, with what size of lettering and font, based on a plurality of options/categories available through a graphical interface 432, using the routing manager 425 to determine optimal route(s) to at least one targeted location, as well as update a graphical map (refer to FIG. 5) to reflect situations where schedules may need updating due to missed appointments, meeting overruns, cancellations, new appointments set, or priorities reassigned, either by a user of a device 410 or a third party with access to the CRM system 423 or CRM service 453, such as, for example, a sales management secretary or office assistant, or in other situations where traffic patterns change, or access to a next appointment becomes impeded, resulting in a revised optimal route to be determined and assigned by the routing manager 425. Use of the mobile CRM system manager 420 may provide users, through their preferred device 410, to access CRM data which may be graphically presented and optioned, for interface and ultimately for real-time integration.

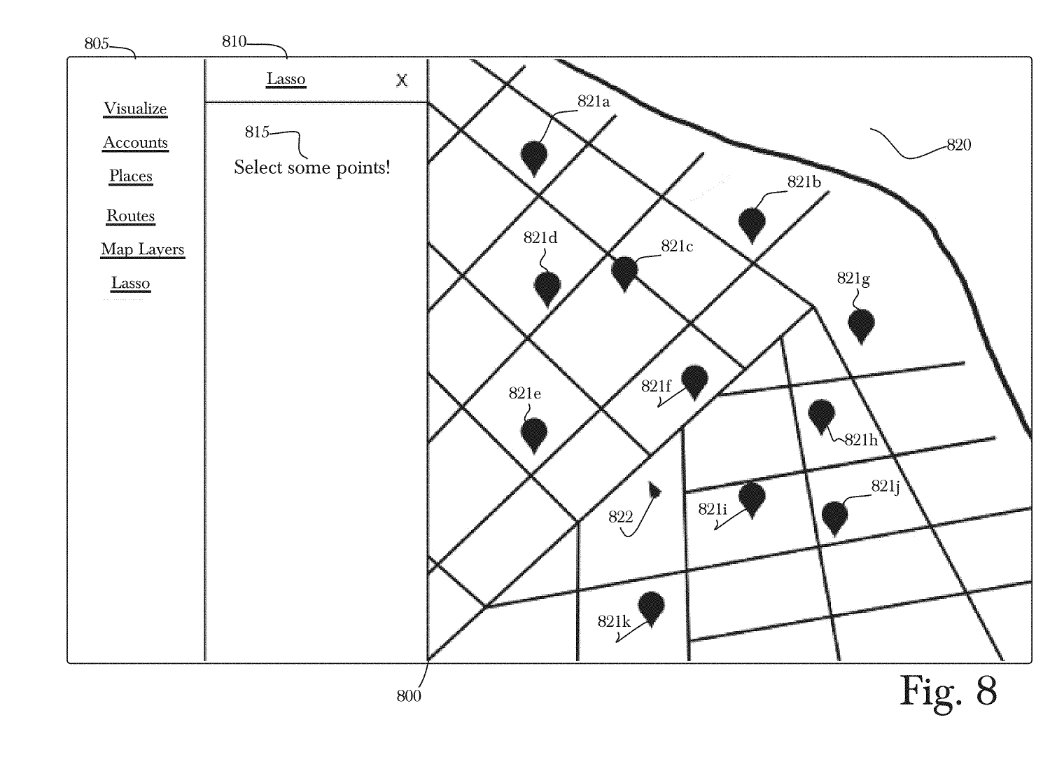

FIG. 5 is a block diagram illustrating an exemplary system 500 architecture for graphically identifying, managing and updating CRM data within a geographic context by at least one device 410 using a mobile CRM system manager 420 connected over a network 501, and also connected to third party web services 450 via a separate network 502, which may be an Internet connection or a separate secure network or communication network. The mobile CRM system manager 420, through its components (as described in FIG. 4) generates a graphical image 510 which is transmitted to the device 410, and with portions of data, may be partially stored on device 410 such that functionality of the mobile CRM system manager 420 does not become impaired if network 501/502 connectivity is lost or a device 410 moves outside a network coverage area. The graphical image 510 is illustrated for exemplary purposes only, and actual imaging, including layout, font, arrangement, color, resolution, etc., may vary and may be arranged to suit preferential desires input for each device 410. Graphical image 510 is further detailed and described in FIGS. 8-17, and while illustrated in a specific way, should be understood as being exemplary and may be rearranged as described above for graphical image 510.

### DETAILED DESCRIPTION OF EXEMPLARY EMBODIMENTS

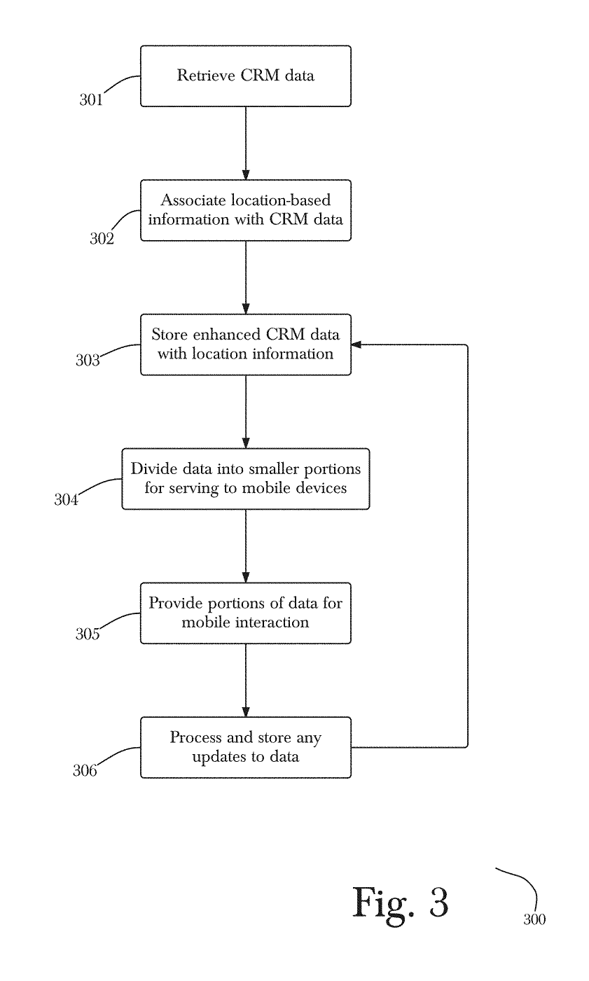

FIG. 3 is a method flow diagram illustrating an exemplary method 300 for providing mobile CRM, according to an embodiment of the invention. According to the embodiment, in an initial step 301 CRM data may be retrieved, such by a tile server 202 from a database 201, such as to make it available for processing or interaction. In a next step 302, CRM data may have location-based information (such as geographic information or other such information that may be considered relevant and useful to the CRM data or functions) associated with it, such as by an object relational mapping server 203 as described above (referring to FIG. 1). In a next step 303, newly-enhanced CRM data with location information may then be stored for future reference, such as to update previous CRM data with location-based information that has been associated with it (thus preventing a need to re-associate location data each time CRM data is loaded, by storing it with CRM data such that location-based information may be made available whenever CRM data is retrieved). In a next step 304, tile server 202 may then divide data into smaller portions, for example based on geographical location (such as displaying only a portion of a CRM database based on a small area of a map being viewed in a mobile CRM application 120, for example), as might be useful for viewing CRM data on devices 110 with hardware limitations such as a mobile smartphone or other mobile or embedded computing device. In this manner, CRM data may be viewed and interacted within a geographic context, regardless of the specific nature of a device being utilized for interaction as the tile server 202 may accommodate the device's 110 limitations by further dividing CRM data such that manageable portions of data are viewed individually rather than attempting to view “too much” data at one time. In a further step 305, “tiles” or portions of data may be provided for interaction, such as by making them available to external applications (for example, via an application programming interface or other software means), such that a user (for example, a mobile salesperson) may view and interact with updated real-time data as desired. In a final step 306, any new changes made may be stored for future use, such as if a mobile salesperson updates any CRM data (for example, managing a customer's account or making a sale, or any other such operation that might involve CRM data), optionally incorporating any new location-based information as appropriate (such as if a customer's geographic information is recorded or updated).

In this manner, it becomes possible for users such as salespersons (or any individual that might view or interact with CRM data, a salesperson is provided as a convenient example that is common in the art) to view, interact with, and manage CRM data while “in the field”, such as while traveling to make sales to new customers or to interact with current customers such as for account maintenance or other such purposes. CRM data may be enhanced with location-based data to increase utility to a user in the field, for example to enable viewing based on location-specific context such as “view all customers within X distance” or “view all customers within Y-travel time” or other such uses, for example. In this manner CRM operations may be improved by making data both more useful and more available to users, and also by enabling users in the field to interact with data immediately as needed (such as when a sale is made) rather than needing to perform updates later or delegate CRM operations to another individual (such as an account service associate in a contact center) that might have access to data in a traditional context.

Additionally, it becomes possible to improve sales or other operations by incorporating routing behavior, such as determining an optimal sales route based on known geographic information in a CRM database. For example, a salesperson might be able to see where existing customers are located and plot a route with maximum probability of making new sales, either manually (such as by interaction with a map or similar location-based display with CRM data) or in an automated or semi-automated manner (for example, by selecting from a list of automatically calculated routes based on available location-enhanced CRM data).

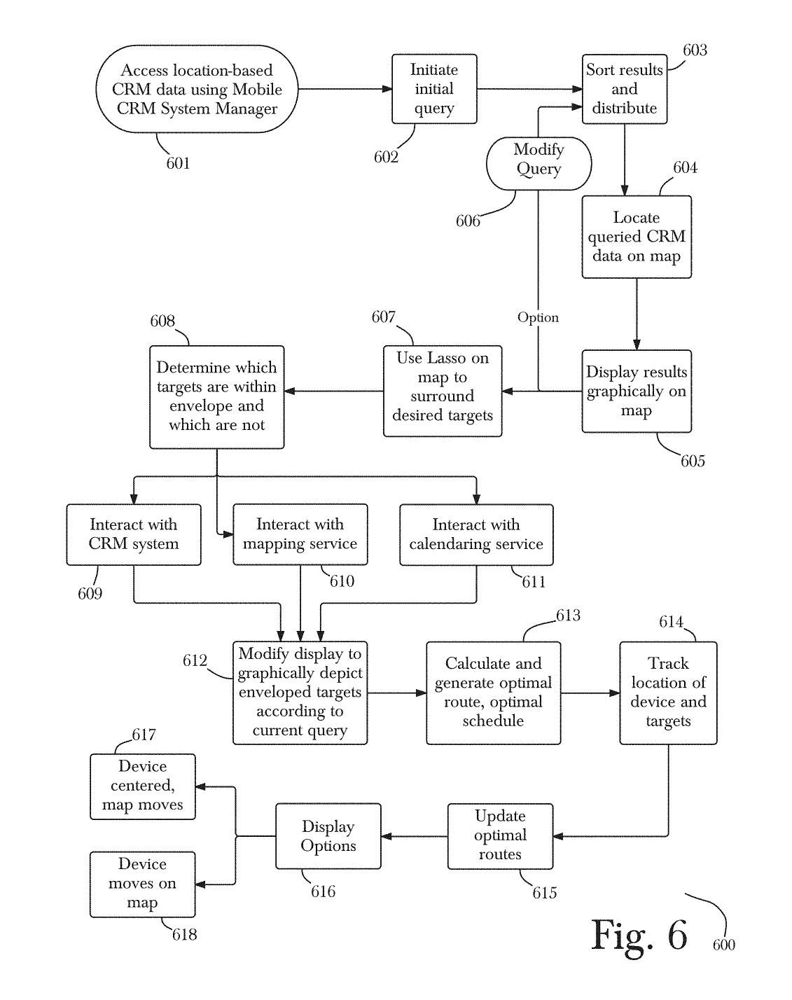

FIG. 6 is a method flow diagram illustrating an exemplary method 600 for graphically identifying, managing and updating CRM data within a geographic context, using a query-‘lasso’ function, according to another embodiment of the invention. According to the embodiment, in an initial step 601 CRM data may be accessed by a mobile CRM system manager 420, such as to make it available for processing or interaction. In a next step 602, a query may be initiated to pull a result set, using query manager 429, which, in a next step 603 sorts results and distributes them to components within the mobile CRM system manager 420, such as the routing manager 425, the tile server 426, the event manager 429 and the location tracker 433, to locate any queried results from the CRM data on a map 604. The tile server 426, along with the display driver 433 and graphical interface 434, display the results graphically on a map 605 illustrated on device 410. At this point, a user may view the results graphically on a mobile map, offered by the selected mapping service 452, and based on preferences and a planned, desired outcome for the results, may opt to modify the query 606 to refine the search and continue in a loop-fashion followed by step 603, or may decide that the results displayed do not need modification, and are sufficient to proceed to a next step 607, whereby a graphical interface 432 may be used to draw a ‘lasso’, comprised of a series of lines, either straight or curved, to encapsulate and surround at least one desired CRM data target 607 on the map produced by step 605. In a next step, the routing manager 425 may determine which targets are within the encapsulated envelope and which are not 608, such that a user device 410 may engage and interact with the CRM system 609, interact with the mapping service 610 and interact with the calendaring service 611, either simultaneously, individually or collectively, to apply queried CRM data results to location and schedule and modify the display to graphically depict the encapsulated targets surrounded by the ‘lasso’ 612, and in a next step, an optimal route and/or schedule is calculated, compared and determined 613 by a route generator 430. A location tracker 433 tracks locations of each device 410 and CRM data targets 614 to feed to the routing manager 425 which may, in a next step, update optimal routes 615 and display options 616 using at least a tile server 426 and display driver 431, to graphically illustrate the results by either showing the device 410 centered on the graphical image 510 whereby the map moves and tracks movement 617 of the device 410, or the device 410 moves on a stationary map view 618, showing an original chosen viewport of related CRM data and the relationship between the device 410 and the original viewport is maintained by showing the device 410 move within the original viewport 618.

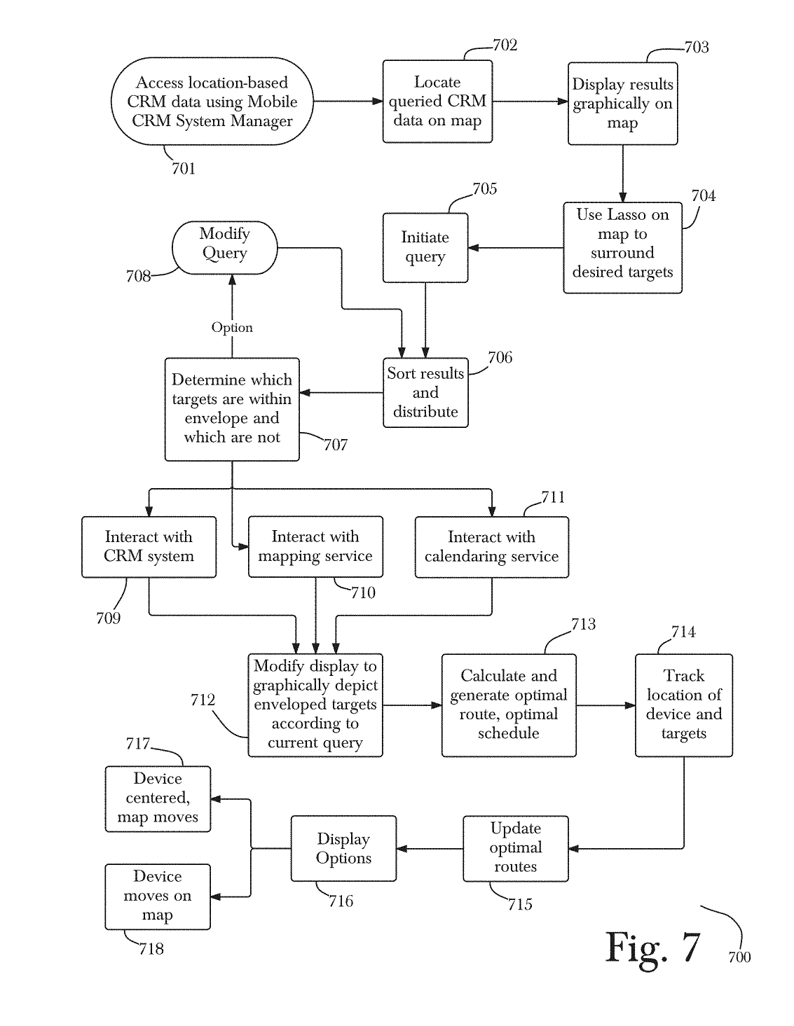

FIG. 7 is a method flow diagram illustrating an exemplary method 700 for graphically identifying, managing and updating CRM data within a geographic context, using a ‘lasso’-query function, according to another embodiment of the invention. According to the embodiment, in an initial step 701 CRM data may be accessed by a mobile CRM system manager 420, such as to make it available for processing or interaction. In a next step 702, CRM data may be visually presented and located on a map, thereby displaying the results graphically on a map 703 illustrated on device 410. A graphical interface 432 may be used to encapsulate or draw a ‘lasso’ comprised of a series of lines, either straight or curved, to surround at least one desired CRM data target 704, within which, a query may be initiated 705 to pull a specified (within the lasso) result set, using query manager 429, and in a next step 706, sorts results and distributes them to components within the mobile CRM system manager 420, such as the routing manager 425, the tile server 426, the event manager 429 and the location tracker 433, using the routing manger 425 to determine which targets are within the encapsulated envelope and which are not 707. At this point, an option is presented to modify the query 708 to refine the search and continue in a loop-fashion followed by step 706; otherwise a user may decide that the results displayed do not need modification, and are sufficient to proceed to engage and interact with the CRM system 709, interact with the mapping service 710 and interact with the calendaring service 711, either simultaneously, individually or collectively, to apply queried CRM data results to location and schedule and modify the display to graphically depict the encapsulated targets surrounded by the ‘lasso’ 712, and in a next step, an optimal route and/or schedule is calculated, compared and determined 713 by a route generator 430. A location tracker 433 tracks locations of each device 410 and CRM data targets 714 to feed to the routing manager 425 which may, in a next step, update optimal routes 715 and display options 716 using at least a tile server 426 and display driver 431, to graphically illustrate the results by either showing the device 410 centered on the graphical image 510 whereby the map moves and tracks movement 717 of the device 410, or the device 410 moves on a stationary map view 718, showing an original chosen viewport of related CRM data and the relationship between the device 410 and the original viewport is maintained by showing the device 410 move within the original viewport 718.

In this manner, it becomes possible for users such as salespersons (or any individual that might view or interact with CRM data, a salesperson is provided as a convenient example that is common in the art) to view, interact with, manage, and update CRM data while “in the field”, such as while traveling to make sales to new customers or to interact with current customers such as for account maintenance or other such purposes. CRM data may be enhanced with location-based data to increase utility to a user in the field, for example to enable viewing based on location-specific context such as “view all customers within X-distance” or “view all customers within Y-travel time” or other such uses, for example. In this manner CRM operations may be improved by making the data both more useful and more available to users, and also by enabling users in the field to interact with CRM data immediately, in real-time, as needed (such as when a sale is made) rather than needing to perform updates later or delegate CRM operations to another individual (such as an account service associate in a contact center) that might have access to the CRM data in a traditional context.

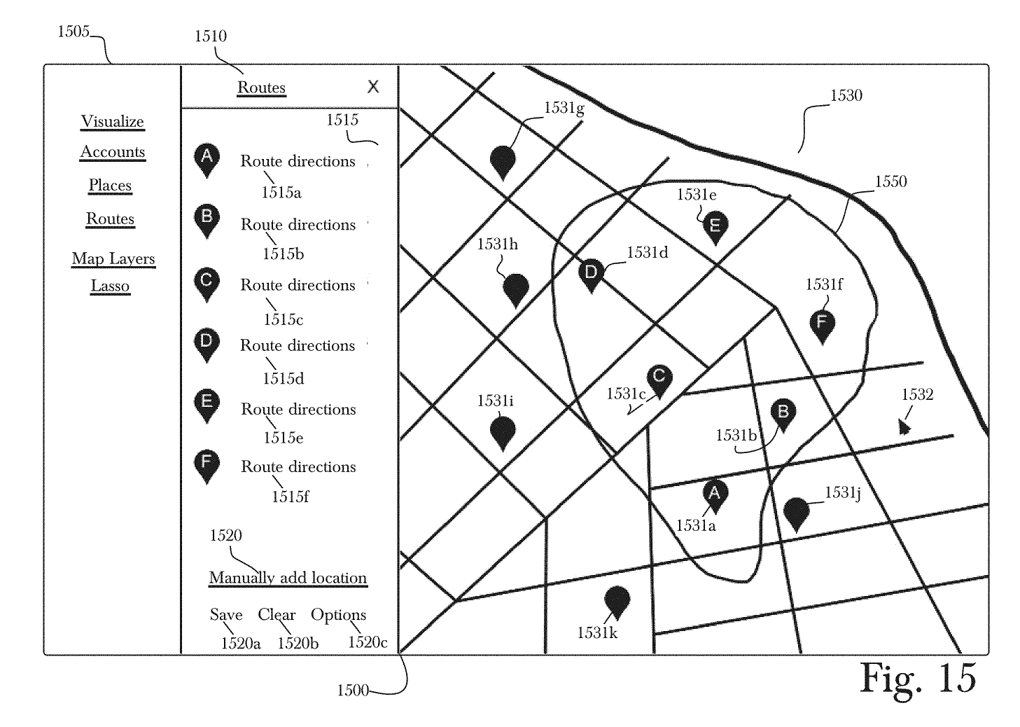

Additionally, it becomes possible to improve sales or other operations by incorporating routing behavior, such as determining an optimal sales route based on known geographic information in a CRM database. For example, a salesperson might be able to see where existing customers are located and plot a route with maximum probability of making new sales, either manually, such as by interaction with a map or similar location-based display with the CRM data, as is described in FIGS. 8-14; or in an automated or semi-automated manner, for example, by selecting from a list of automatically calculated routes based on the location-enhanced CRM data available, as is depicted in FIGS. 15-17. Referring back to FIG. 5, graphical image 510 is presented in multiple forms, in FIGS. 8-17.

FIG. 8 is an exemplary user interface diagram 800 depicting an exemplary system and method for graphically identifying, managing and updating CRM data within a geographic context, using a lasso function 810, according to an embodiment of the invention. For the purposes of illustrating the lasso function 810, FIGS. 8, 9, 10, 11, 12, 13, and 14 are presented in series, with each user interface diagram 800/900/1000/1100/1200/1300/1400 depicting specific items relevant to a progression. Options are presented in a field 805, such as selectable icons, in this example, ‘Visualize’, ‘Accounts’, ‘Places’, ‘Routes’, ‘Map Layers’, and ‘Lasso’. With a ‘Lasso’ function selected, field 810 identifies ‘Lasso’ with instructions in a lower, associated field 815, in this case, ‘Select some points!’. An interactive map 820 may illustrate a series of CRM data targets 821a/b/c/d/e/f/g/h/i/j/k, where each data target may represent a customer or client or other such located data point related to the CRM system, being a desirable location to visit. A pointer 822 may be used to interact within the graphical image 800, to select, draw, or otherwise action various fields as previously described.

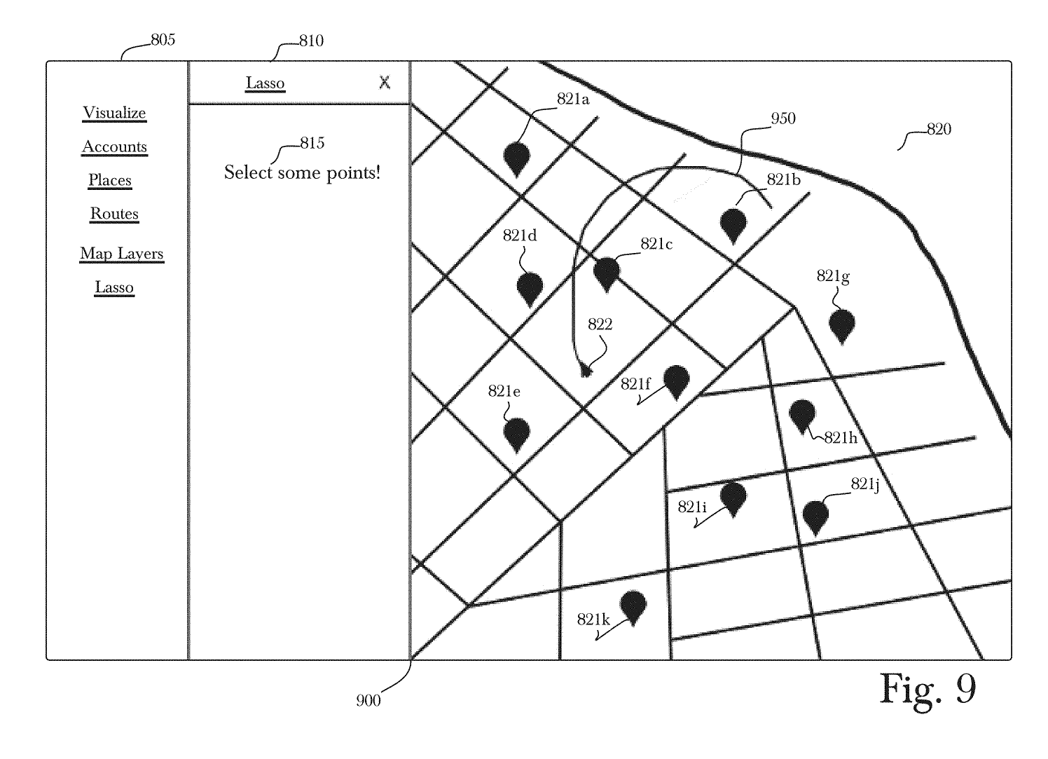

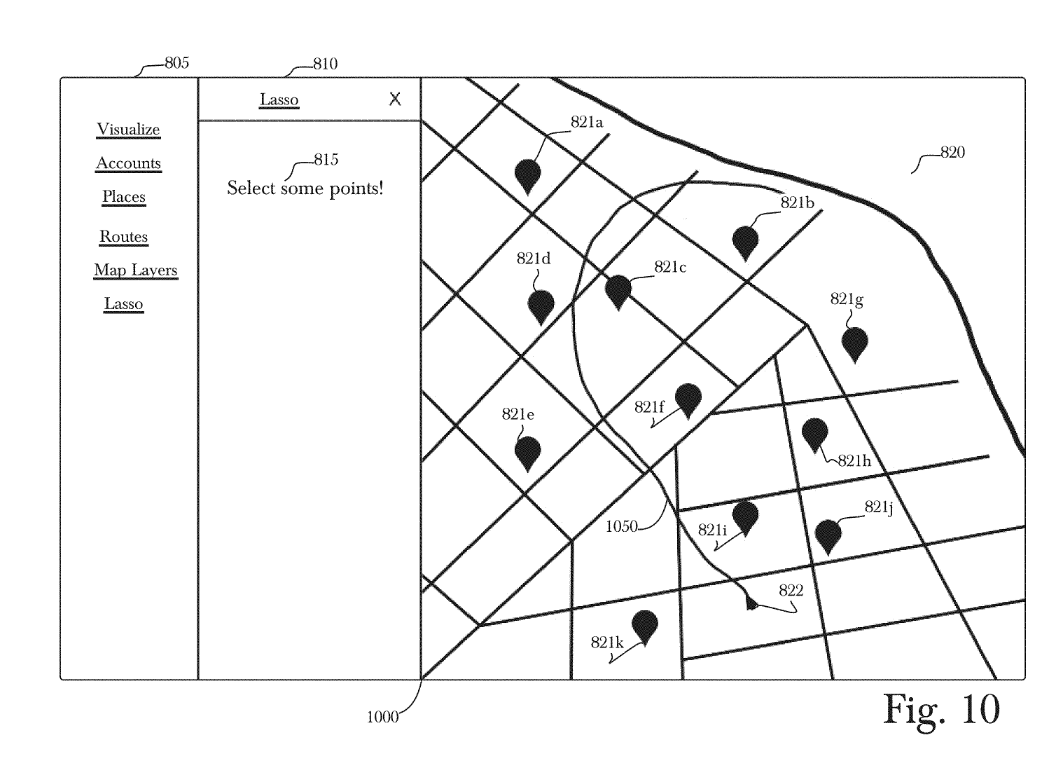

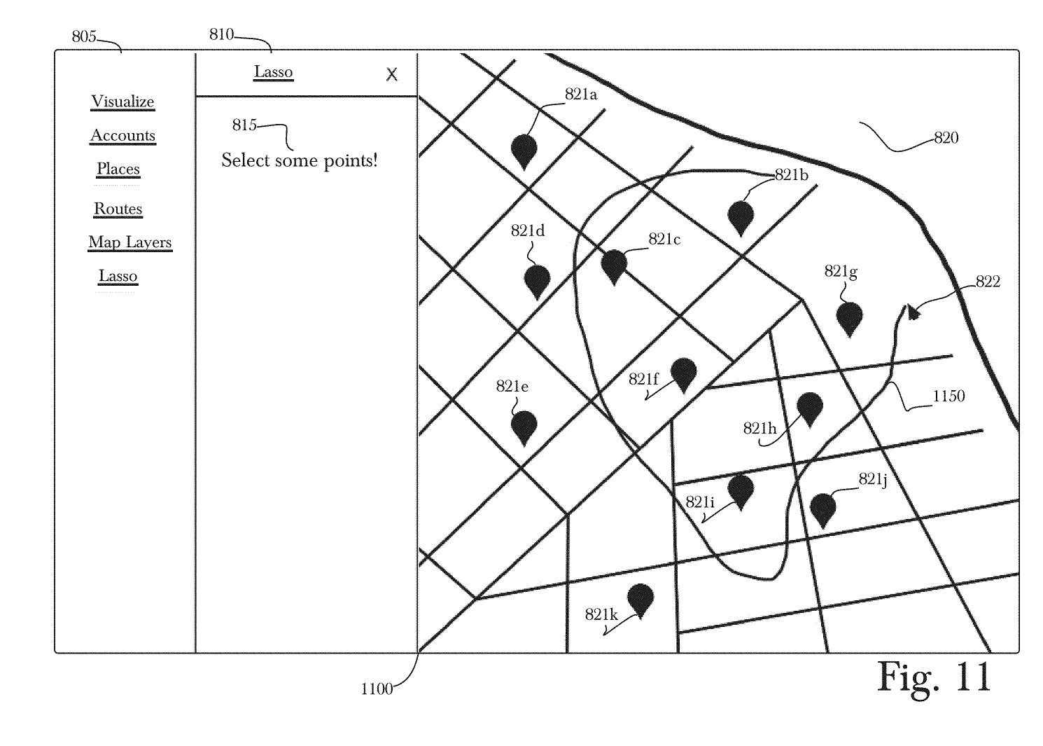

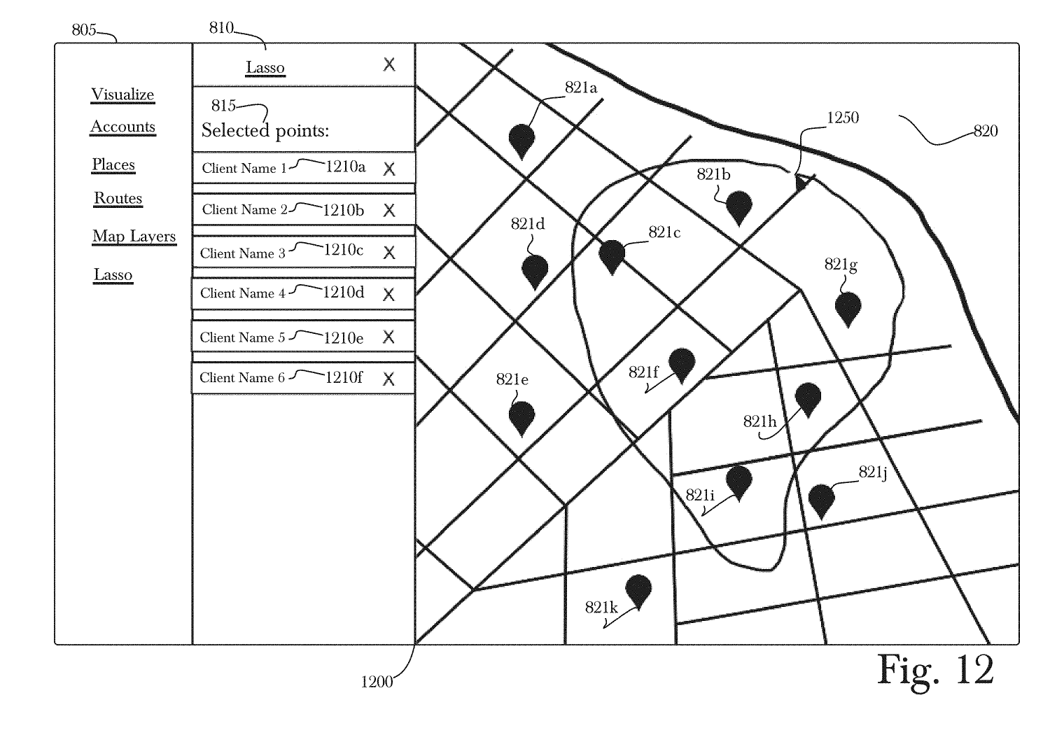

FIG. 9 is an exemplary user interface diagram 900 depicting an exemplary system and method for graphically identifying, managing and updating CRM data within a geographic context, using a lasso function 810, according to an embodiment of the invention. Moving the pointer 822, as shown in FIG. 9, a continuous free-hand curvaceous line 950 may be drawn, starting at a point near target 821b, following a counter-clockwise motion around target 821c, separating data target 821c from 821d. Similarly, following on in series in FIG. 10, pointer 822 may be moved within graphical image 1000 along a path 1050, further separating data targets 821f from 821e, and 821i from 821k. Continuing on in series in FIG. 11, pointer 822 may be moved within graphical image 1100 along a path 1150 to continue to isolate a group of data targets, further separating 821g and 821h from 821j, thereby nearly completely isolating 821b/c/f/g/h/i from the overall set 821a-821k, with the completed lasso being illustrated in FIG. 12, in graphical image 1200 along a path 1250.

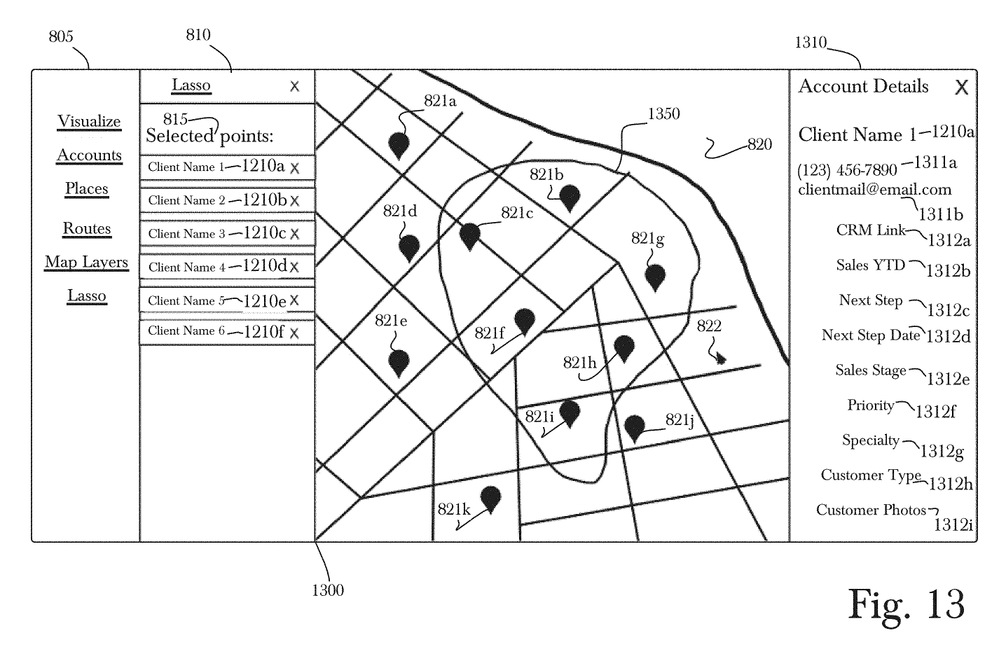

FIG. 12 is an exemplary user interface diagram 1200 depicting an exemplary system and method for graphically identifying, managing and updating CRM data within a geographic context, using a lasso function 810, according to an embodiment of the invention. Once a ‘lasso’ action has been completed 1350, or nearly completed, as illustrated by the path 1250, the data targets 821b/c/f/g/h/i within the lasso path 1250 may be accessed and represented according to their respective data from within the CRM system 423 or CRM service 453, in a field under the lasso function 810, depicting various Client details 1210a/b/c/d/e/f, corresponding to the data targets 821b/c/f/g/h/i within the lasso path 1250. Client details may be accessed individually, possibly denoted as account details 1310, as depicted in graphical image 1300 within FIG. 13.

FIG. 13 is an exemplary user interface diagram 1300 depicting an exemplary system and method for graphically identifying, managing and updating CRM data within a geographic context, using a lasso function 810, according to an embodiment of the invention. Account details 1310 associated with a Client Name 1210a, corresponding to data target 821b, are drawn from the CRM system 423 or CRM service 453 to provide an interactive interface for identifying, managing, and updating CRM data fields, which may include, but not be limited to, phone number 1311a, email address 1311b, as well as an additional options menu associated with the account details 1310 in which various aspects may be accessed, managed and/or updated, including, but not limited to, linking 1312a to the CRM system 423 or CRM service 453; accessing year-to-date sales 1312b; retrieving information pertaining to a next step 1312c and/or next step date 1312d; reviewing a sales stage 1312e; or a priority 1312f; or a possibly a specialty 1312g, or other customer-related fields, such as type 1312h, or photos 1312i. The list above is provided for example only, and is provided to exemplify a series of fields that may be accessed, but should not be construed to be limited to only the fields 1312a-i listed.

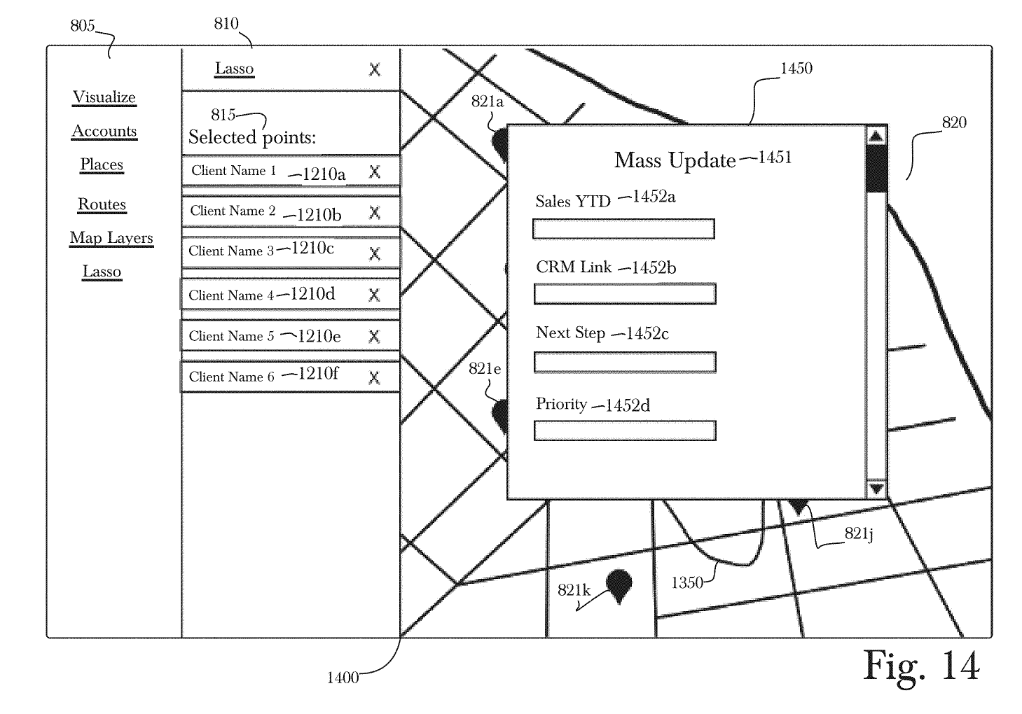

FIG. 14 is an exemplary user interface diagram 1400 depicting an exemplary system and method for graphically identifying, managing and updating CRM data within a geographic context, using a lasso function 810, according to an embodiment of the invention. Following the series of possible actions depicted in FIGS. 8-13, CRM data may also be manually updated, as depicted in an update interface 1450, providing access to a type of update 1451, with respective fields 1452a/b/c/d available in view, for interaction and managing via the graphical interface 432. The list of fields 1452a/b/c/d is provided for example only, and is provided to exemplify a series of fields that may be accessed, but should not be construed to be limited to only the fields 1452a-d.

FIG. 15 is an exemplary user interface diagram 1500 depicting an exemplary system and method for graphically identifying, managing and updating CRM data within a geographic context, using a ‘route’ function 1510, according to an embodiment of the invention. For the purposes of illustrating the route function 1510, FIGS. 15, 16, and 17 are presented in series, with each user interface diagram 1500/1600/1700 depicting specific items relevant to a progression. Similar to that shown in FIG. 8, options are presented in a field 1505, such as selectable icons, in this example, ‘Visualize’, ‘Accounts’, ‘Places’, ‘Routes’, ‘Map Layers’, and ‘Lasso’. With a ‘Route’ function selected, field 1510 identifies ‘Route’ with instructions in a lower, associated field 1515, in this case, ‘Route directions’ 1515a associated with data target ‘A’ 1531a shown graphically in an interactive map 1530. A series of CRM data targets 1531a/b/c/d/e/f/g/h/i/j/k, are depicted, where each data target may represent a customer or client or other such located data point related to the CRM system, being a desirable location to visit. A pointer 1532 may be used to interact within the graphical image 1500, to select, draw, or otherwise action various fields as described. A lasso path 1550 may be added using the pointer 1532 in a similar fashion as described above in FIG. 9 to select and encapsulate a series of desired data targets, for example, targets ‘A’ 1531a, ‘B’ 1531b, ‘C’ 1531c, ‘D’ 1531d, ‘E’ 1531e, and ‘F’ 1531f. With target ‘A’ 1531a identified, the route directions 1515a are determined and shown in field 1515 as being available for selection. Similarly, target ‘B’ 1531b is linked to the route directions 1515b; target ‘C’ 1531c is linked to route directions 1515c; target ‘D’ 1531d is linked to route directions 1515d; target ‘E’ 1531e is linked to route directions 1515e; and target ‘F’ is linked to route directions 1515f. Directions may be determined for access to any known target, with a plurality of choices given for each. Routes are updated in real-time, as data is available, which may, in turn, alter route options and optimal directions selected. Additionally, locations not listed within the active CRM system 423 or CRM service 453 may be manually added, within an optional interface ‘Manually add location’ 1520, including a subset of options, which may include items like ‘Save’ 1520a, ‘Clear’ 1520b or ‘Options’ 1520c, which are listed as an example of fields that may be available. Depending on mapping options selected, routes may be determined for a device 410 to traverse, either by travelling on streets or walking, meaning, by wheeled vehicle or on foot. Indicia of routes are not illustrated, but may be envisaged as a high-lighted route, meaning different coloring, bolder lines over, or less transparent lines, or any combination thereof.

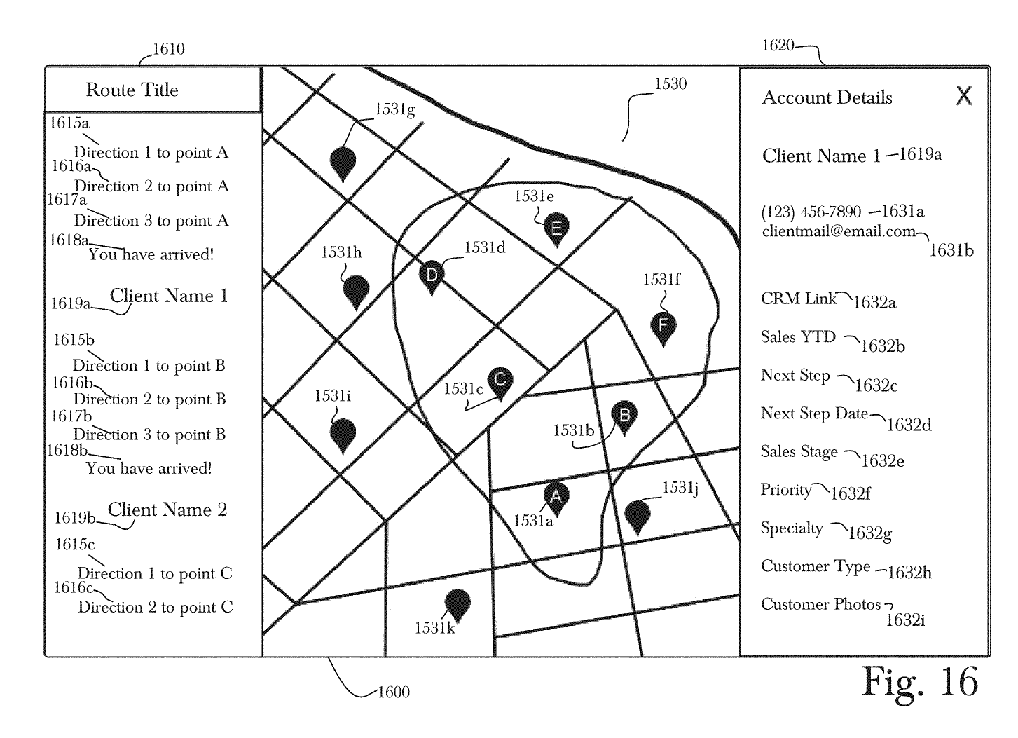

FIG. 16 is an exemplary user interface diagram 1600 depicting an exemplary system and method for graphically identifying, managing and updating CRM data within a geographic context, using a ‘route’ function 1510, according to an embodiment of the invention. Following on from FIG. 15 depicting a user interface diagram 1500, FIG. 16 illustrates a next screen, showing route directions to target ‘A’ 1531a, from a known starting point, with a first directional step ‘Direction 1 to point A’ 1615a, followed next steps 1616a, 1617a, and a final arrival notification 1618a. A client name 1619a associated with data target ‘A’ 1531a may be drawn upon, and further optioned in a field 1620, identifying account details from the CRM system 423 or CRM service 453 to provide an interactive interface for identifying, managing, and updating CRM data fields, which may include, but not be limited to, phone number 1631a, email address 1631b, as well as an additional options menu associated with the account details 1620 in which various aspects may be accessed, managed and/or updated, including, but not limited to, linking 1632a to the CRM system 423 or CRM service 453; accessing year-to-date sales 1632b; retrieving information pertaining to a next step 1632c and/or next step date 1632d; reviewing a sales stage 1632e; or a priority 1632f; or a possibly a specialty 1632g, or other customer-related fields, such as type 1632h, or photos 1632i. The list above is provided for example only, and is provided to exemplify a series of fields that may be accessed, but should not be construed to be limited to only the fields 1632a-i listed.

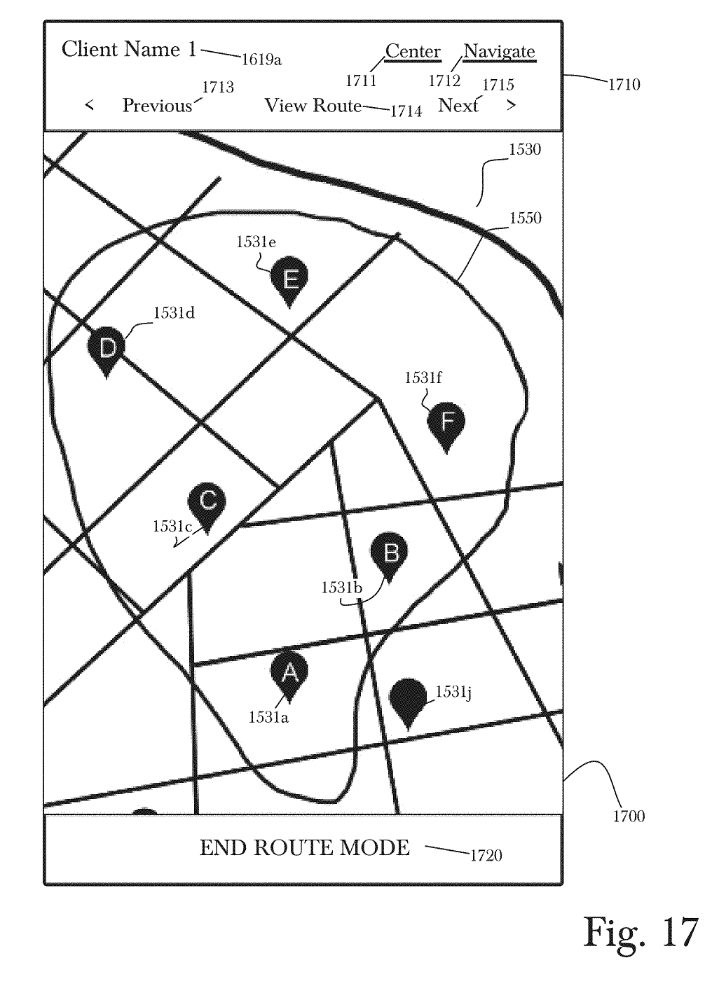

FIG. 17 is an exemplary user interface diagram 1700 depicting an exemplary system and method for graphically identifying, managing and updating CRM data within a geographic context, using a ‘route’ function 1510, according to an embodiment of the invention. Following on from FIG. 15 depicting a user interface diagram 1500, FIG. 17 illustrates a final screen, 1700, with the interactive map 1530, a navigation interface 1710 and a status notification ‘END ROUTE MODE’ 1720. Within the navigation interface 1710, client details 1619a may be reviewed, with options to center 1711 the map view 1530 over the associated data target (in this case, data target ‘A’ 1531a as associated with Client Name 1 1619a) or else Navigate 1712 around a selected data target. Other toggles may include an ability to scroll through option screens, by selecting ‘Previous’ 1713 or ‘Next’ 1715. Additionally, route options may be illustrated and toggled through by selecting ‘View Route’ 1714.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

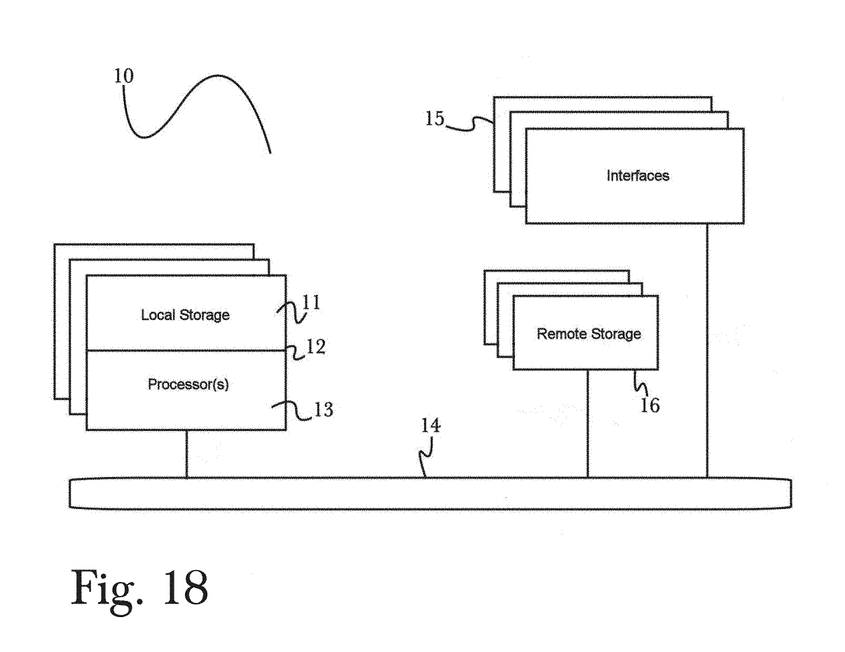

Referring now to FIG. 18, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 18 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

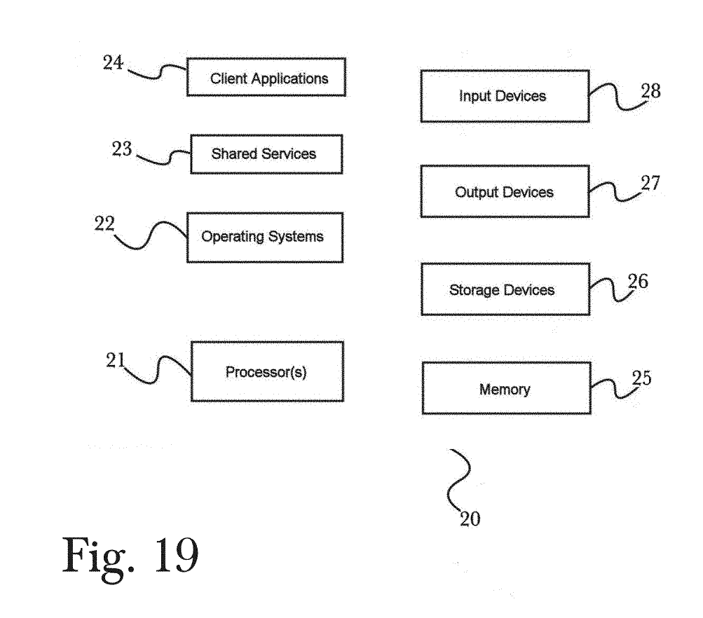

In some embodiments, systems according to the present invention may be implemented on a standalone computing system. Referring now to FIG. 19, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 18). Examples of storage devices 26 include flash memory, magnetic hard drive, CD-ROM, and/or the like.

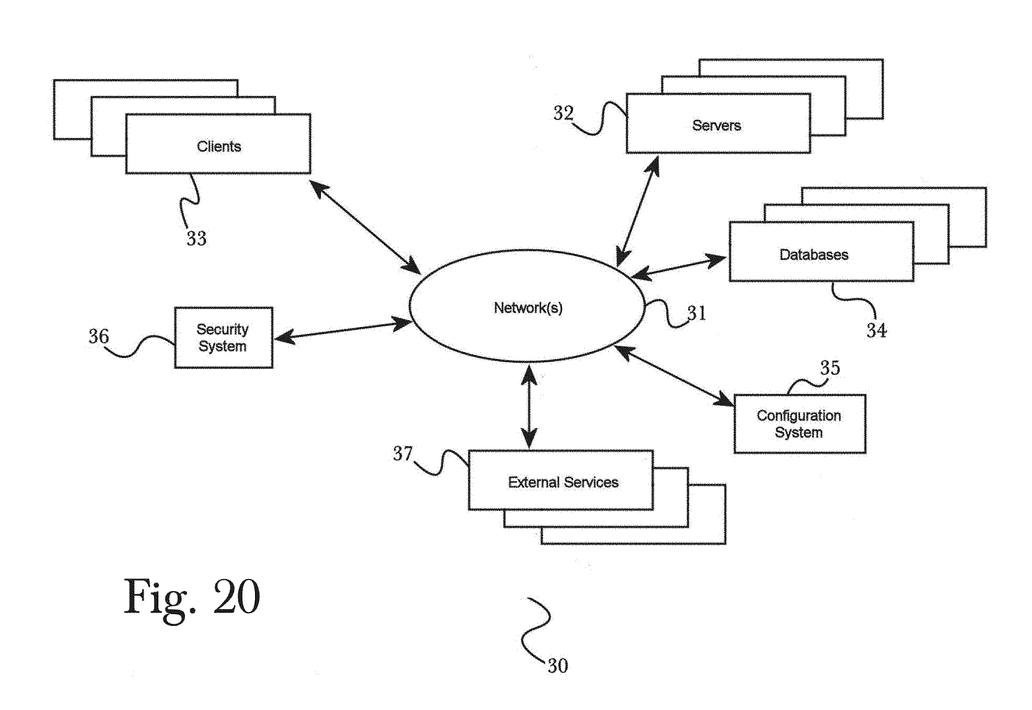

In some embodiments, systems of the present invention may be implemented on a distributed computing network, such as one having any number of clients and/or servers. Referring now to FIG. 20, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 19. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

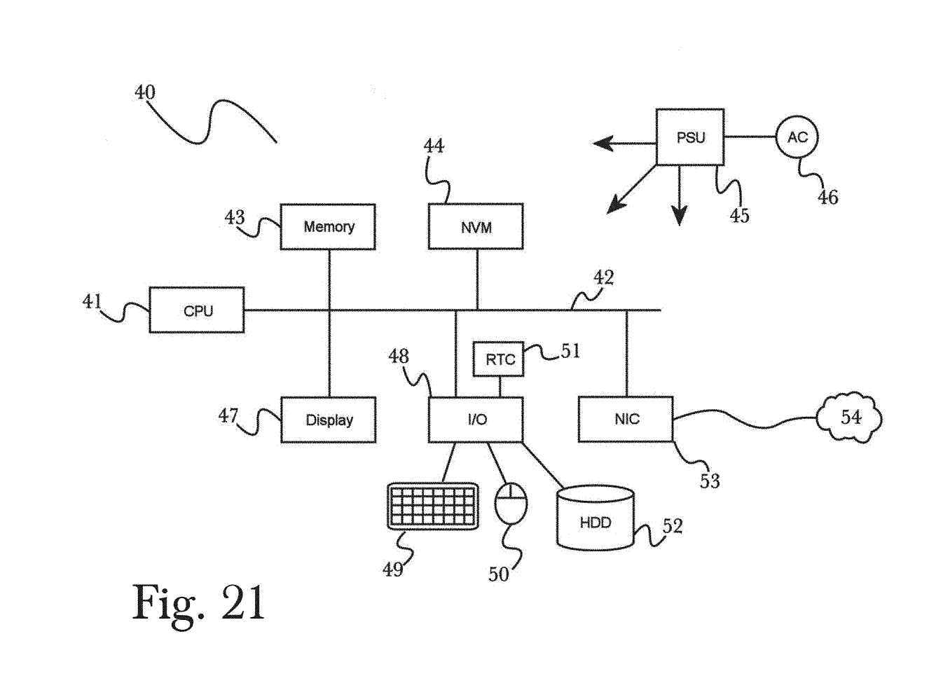

FIG. 21 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for mobile customer relations management of a customer relations management system or network, using a mobile customer relations management system manager, comprising:
at least one mobile-capable network-connected computing device, comprising a processor, a memory, and a plurality of programming instructions stored in the memory and operable on the processor;
wherein the plurality of programming instructions are configured to graphically identify, manage and update customer relations management data in a geographic context; and
wherein the plurality of programming instructions are configured organize customer relations management data based on at least one specific real-time variable associated with the customer relations management system.

2. The system of claim 1, with the mobile customer relations management system manager further comprising:
a customer relations management system connected to a database containing customer relations management information and data, stored and operating on a network-connected computing device;
a routing manager, stored and operating on a network-connected computing device, configured to manage routing by way of interaction with a mapping service, a location tracker and a routing generator;
an event manager with access to a calendaring server, stored and operating on a network-connected computing device, configured to manage events in calendars, associated with the customer relations management data;
a tile server stored and operating on a network-connected computing device, configured to provide data portions of customer relations management data to a graphical interface in conjunction with a display driver, and display images and options in highlighted colors, hues, transparencies, and other visually stimulating indicia to indicate at least an optimal routing option;
a display driver stored and operating on a network-connected computing device, configured to decide what to show based on a query made by the query manager, yielding a ‘result set’, and to decide what imagery and data to send to the tile server, what icon to display for a target, what color to display, what a mapped illustration may look like, with what size of lettering and font, based on a plurality of options/categories available through a graphical interface;
a query manager stored and operating on a network-connected computing device, configured to select, query and return a data set based on a text-based or graphical query against data in the customer relations management system;
a graphical interface stored and operating on a network-connected computing device, configured to interact with the mobile customer relations management system manager and a mobile network-connected device; and
an object-relational mapping system, stored and operating on a network-connected computing device, with access to an object-relational mapping database;
wherein the query manager identifies data targets from customer relations management information provided by a customer relationship management service via a network to derive a subset of customer relationship management information relevant to a business user at a specific location;
wherein the object relational mapping server associates location information received from a mobile device of a business user with customer relations management information provided by a customer relationship management service via a network to derive a subset of customer relationship management information relevant to a business user at a specific location;
wherein the tile server transmits the derived subset of customer relationship management information for display as a map overlay on the mobile-capable network-connected computing device;
wherein the routing manager incorporates routing results from the routing generator and location results from the location tracker to determine optimal routes for accessing a business user's location;
wherein the event manager associates schedules and appointment timings from a calendaring server connected to a mobile-capable network-connected computing device of a business user with customer relations management information provided by a customer relationship management service via a network to derive a subset of customer relationship management information relevant to the business user at a specific location; and
wherein customer relations management data is a derived subset of customer relationship management information comprising at least a plurality of identities of existing customers located near a business user.

2. The system of claim 2, wherein the customer relations management information comprises at least geographical data.

3. The system of claim 2, wherein the mobile customer relations management system manager accesses at least one calendar from a third party calendaring service.

4. The system of claim 2, wherein the mobile customer relations management system manager accesses a customer relations management system from a third party customer relations management service.

5. The system of claim 2, wherein the mobile customer relations management system manager accesses a geographical map from a third party mapping service.

6. The system of claim 2, further comprising an application server stored and operating on a network-connected computing device, wherein the application server operates a software module for enabling a human user to interact with the customer relations management data.

7. The system of claim 6, further comprising a web server stored and operating on a network-connected computing device, wherein the web server facilitates network-based interaction with the software module.

8. The system of claim 7, wherein the mobile customer relations management system manager accesses at least one calendar from a third party calendaring service.

9. The system of claim 7, wherein the mobile customer relations management system manager accesses a customer relations management system from a third party customer relations management service.

10. The system of claim 7, wherein the mobile customer relations management system manager accesses a geographical map from a third party mapping service.

11. The system of claim 1, wherein the customer relations management information comprises at least geographical data.

12. A method to graphically identify, manage and update customer relations management data within a geographic context, and organize it based on at least one specific queried variable, using a query-lasso function, activated by a mobile customer relations management system manager working in real-time, comprising the steps of:
(a) accessing location-based customer relations management data within a customer relations management system, using a mobile customer relations management system manager;
(b) initiating an initial query against the customer relations management data using a query manager;
(c) processing and sorting, with the query manager, and further distributing queried results as data targets to applicable components within the mobile customer relations management system manager;
(d) locating the customer relations management data targets on an electronic map;
(e) displaying results graphically on the electronic map in a display window, affording a plurality of optional visual indicia which may be used to highlight any queried features;
(f) optionally modifying the initial query against the customer relations management data using a query manager and repeating steps (c), (d), and (e);
(g) drawing, with a graphical interface, a ‘lasso’, comprised of a series of lines, either straight or curved, to encapsulate and surround at least one desired customer relations management data target;
(h) determining, with a routing manager, which data targets are within the encapsulated envelope surrounded by the lasso, and which data targets are not within the lasso;
(i) engaging and interacting with the customer relations management system, the mapping service, and/or the calendaring service, either simultaneously, individually or collectively, to apply queried customer relations management data results to location and schedule;
(j) modifying the display window to graphically depict the encapsulated data targets surrounded by the ‘lasso’;
(k) calculating and generating at least one optimal route or optimal schedule of appointments occurring at a plurality of locations;
(l) tracking, with a location tracker, locations of all data targets and mobile devices accessing the mobile customer relations management system manager;
(m) updating optimal routes in real-time, using the routing manager of the mobile customer relations management system manager; and
(n) graphically illustrating the optimal route by displaying the location of the mobile customer relations management system manager centered on a graphical image of the electronic map whereby the map moves and tracks movement as the location of the mobile customer relations management system manager changes; or
(o) graphically illustrating the optimal route by displaying the location of the mobile customer relations management system manager moving about on a graphical image of the electronic map whereby the location of the mobile customer relations management system manager moves about on a static view of the electronic map.

13. A method to graphically identify, manage and update customer relations management data within a geographic context, and organize it based on at least one specific queried variable, using a lasso-query function, activated by a mobile customer relations management system manager working in real-time, comprising the steps of:
(a) accessing location-based customer relations management data within a customer relations management system, using a mobile customer relations management system manager;
(b) locating the customer relations management data targets on an electronic map;
(c) displaying results graphically on the electronic map in a display window, affording a plurality of optional visual indicia which may be used to highlight any queried features;
(d) drawing, with a graphical interface, a ‘lasso’, comprised of a series of lines, either straight or curved, to encapsulate and surround at least one desired customer relations management data target;
(e) initiating a query against the customer relations management data using a query manager;
(f) processing and sorting, with the query manager, and further distributing queried results as data targets to applicable components within the mobile customer relations management system manager;
(g) determining, with a routing manager, which data targets are within the encapsulated envelope surrounded by the lasso, and which data targets are not within the lasso;
(h) optionally modifying the query against the customer relations management data using a query manager and repeating steps (f) and (g);
(i) engaging and interacting with the customer relations management system, the mapping service, and/or the calendaring service, either simultaneously, individually or collectively, to apply queried customer relations management data results to location and schedule;
(j) modifying the display window to graphically depict the encapsulated data targets surrounded by the ‘lasso’;
(k) calculating and generating at least one optimal route or optimal schedule of appointments occurring at a plurality of locations;
(l) tracking, with a location tracker, locations of all data targets and mobile devices accessing the mobile customer relations management system manager;
(m) updating optimal routes in real-time, using the routing manager of the mobile customer relations management system manager; and
(n) graphically illustrating the optimal route by displaying the location of the mobile customer relations management system manager centered on a graphical image of the electronic map whereby the map moves and tracks movement as the location of the mobile customer relations management system manager changes; or
(o) graphically illustrating the optimal route by displaying the location of the mobile customer relations management system manager moving about on a graphical image of the electronic map whereby the location of the mobile customer relations management system manager moves about on a static view of the electronic map.
